(19) United States
(12) Patent Application Publication
(10) Pub. No.: US 2010/0103332 A1
(43) Pub. Date: Apr. 29, 2010

(54) IMAGE PROJECTOR DRIVING MULTIPLE DISPLAY SCREENS

(75) Inventors: Zili Li, Barrington, IL (US); George T. Valliath, Winnetka, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/258,633

(22) Filed: Oct. 27, 2008

(51) Int. Cl. H04N 5/74

(52) U.S. Cl. 348/750; 348/E05.137

(57) ABSTRACT

Disclosed is a personal portable device that includes a microprojector. The microprojector creates an image for display. The image is sent to a “beam-switching element” that shunts the image toward a selected display screen (e.g., a display screen on the device or an off-device projection). The image is then displayed on the selected screen. By commanding the beam-switching element to change its configuration, different screens can be driven by the same microprojector. The combination of a single microprojector with multiple display screens gives the personal portable device the flexibility of multiple displays while preserving space within the device and, in some embodiments, lowering power consumption. In some embodiments, the microprojector simultaneously drives more than one display screen. The driven display screens may display the same or different images, and the images displayed may be of the same or of different resolutions.

### FIELD OF THE INVENTION

The present invention is related generally to projectors of optical images, and, more particularly, to optical-image projectors subject to space or power-consumption limitations.

### BACKGROUND OF THE INVENTION

A trend in personal portable devices (such as cell phones and personal digital assistants) is to add new features while keeping the devices small. Many of these new features display information visually. For example, a high-resolution, easy-to-read display screen is provided to support photograph sharing and video downloading. Many devices also include a separate, smaller or lower-resolution display screen on the outside of the device for status messages.

In addition to these display screens on the device itself, some devices may soon incorporate a “microprojector.” Here, an image, either still or moving, is projected from the device onto a convenient surface (e.g., a projection screen or an office wall). The maximum size of the image is then effectively constrained only by the amount of available wall space rather than by the size of the device itself. Using a microprojector-equipped device, several people can simultaneously view a photograph, for example, or review a full page of text, neither of which can be readily done with even the largest displays on current personal portable devices.

Useful as these multiple display screens are, they raise new challenges when engineers attempt to support all of them in one personal portable device. The packaging problems are exacerbated by the trend toward smaller and thinner devices.

Power use is another challenge. It takes a significant amount of electrical power to simultaneously support a number of display screens, especially if one of the screens is a large display area outside the device. Designers of battery-based personal portable devices are already concerned about their power budgets and look askance at any new feature that threatens to reduce the utility of the device by reducing how long the device can operate between charges.

### BRIEF SUMMARY

The above considerations, and others, are addressed by the present invention, which can be understood by referring to the specification, drawings, and claims. According to aspects of the present invention, a personal portable device includes a microprojector that creates an image for display. The image is sent to a “beam-switching element” that shunts the image toward a selected display screen (e.g., a display screen on the device or an off-device projection surface). The image is then displayed on the selected screen. By commanding the beam-switching element to change its configuration, different screens can be driven by the same microprojector.

The combination of a single microprojector driving multiple display screens gives the personal portable device the flexibility of multiple displays while preserving space within the device and, in some embodiments, lowering power consumption. For example, a device can be designed that is very thin but still incorporates multiple display screens.

In some embodiments, the microprojector simultaneously drives more than one display screen. The driven display screens may display the same or different images, and the images displayed may be of the same or of different resolutions.

Power consumption is lowered in some embodiments by varying the amount of power consumed by the microprojector based on the display screen (or screens) in use at any one time. For example, less power could be consumed when off-device projection is not in use.

To enhance packaging flexibility, in some embodiments one or more light guides carry images from the beam-switching element to one or more display screens.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIGS. 1a, 1b, and 1c are block diagrams of a personal portable device with three display screens;

FIG. 2a is a simplified schematic view of a device directing an image to a display screen on the device, according to one aspect of the present invention;

FIG. 2b is a simplified schematic of the device of FIG. 2a now projecting the image to an off-device screen;

FIG. 2c is a simplified schematic of the device of FIG. 2a simultaneously directing images to two different display screens;

FIG. 3 is a flowchart of an exemplary embodiment of the present invention; and

FIG. 4 is a simplified schematic of an exemplary device with a curved light guide directing an image to a display screen.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

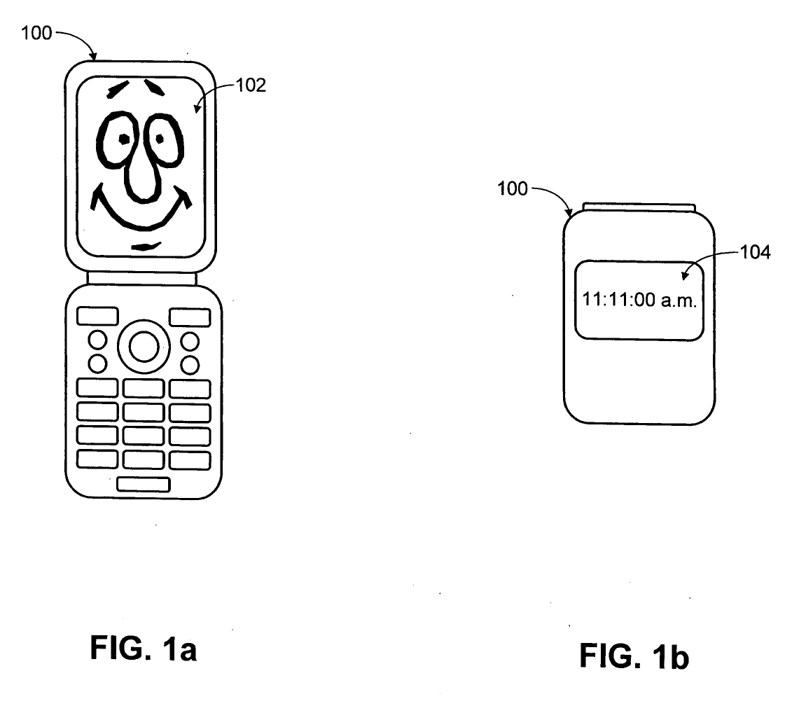

FIGS. 1a, 1b, and 1c show a personal portable device 100 (e.g., a cellphone, personal digital assistant, or personal computer) that incorporates an embodiment of the present invention in order to support multiple display screens. This particular device 100 has three display screens. First, FIG. 1a shows the device 100 in an open configuration, presenting its main display 102 to a user. Typically, the main display 102 is used for most high-fidelity interactions with the user. For example, the main display 102 is used to show video or still images, is part of a user interface for changing configuration settings, and is used for viewing call logs and contact lists. To support these interactions, the main display 102 is of high resolution and is as large as can be comfortably accommodated in the device 100. (The “resolution” of a digital image is defined as the product of its horizontal resolution and its vertical resolution. Resolution is measured in number of pixels. Note that here “horizontal” and “vertical” are merely convenient, and conventional, names for the two dimensions of a planar image and are not confined to orientations taken with respect to the direction of gravity.)

When the device 100 is closed, as in FIG. 1b, a secondary display 104 is readily visible. This secondary display 104 is often used for status messages (such as the time of day) and is generally of lower resolution and of smaller size than the main display 102.

FIG. 1c illustrates a third display screen. In the figure, a user 106 is projecting an image 108 from her personal portable device 100. The image 108 could be, for example, a photograph, a video, or a computerized display from a word processor or an Internet browser. The image 108 may be projected onto a screen or even onto a wall or ceiling. By projecting the large, high resolution image 108 rather than presenting it on a (necessarily small) display screen 102 or 104 of her personal portable device 100, the user 106 can invite others to share the image 108 with her.

Prior to the present invention, the personal portable device 100 would have to incorporate within it three sets of display electronics, one set for each of the three display screens 102, 104, and 108. These three sets of display electronics increase the cost of the device 100 and consume significant amounts of its limited volume.

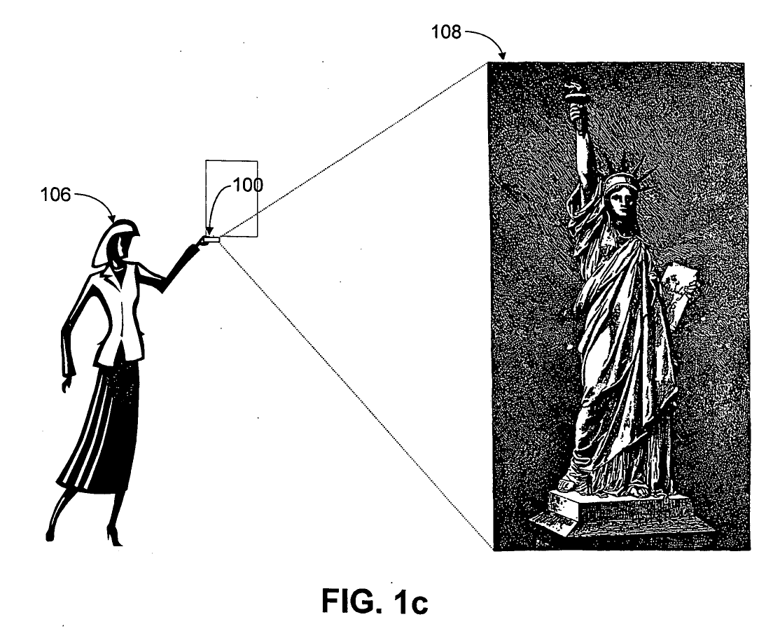

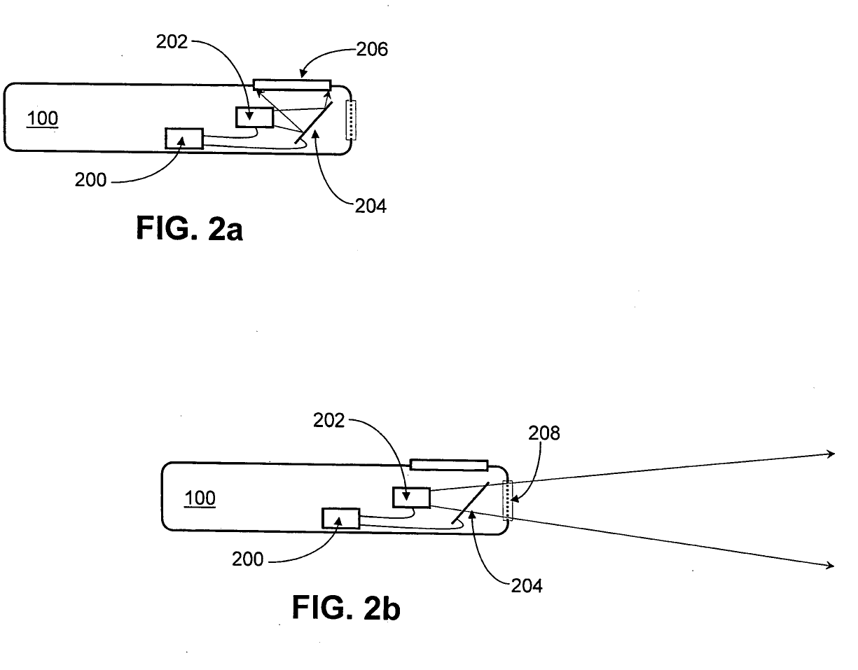

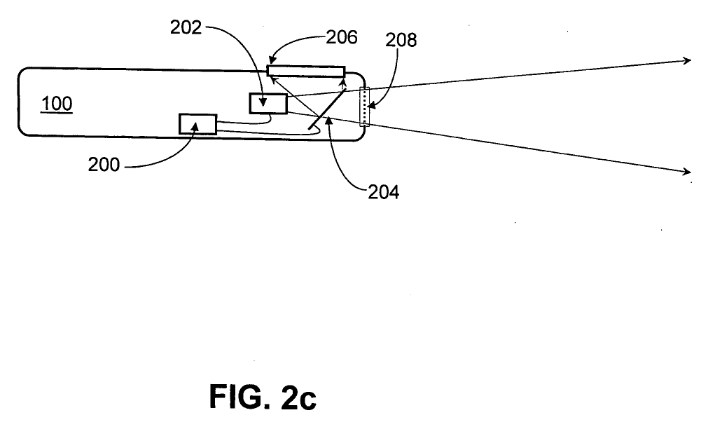

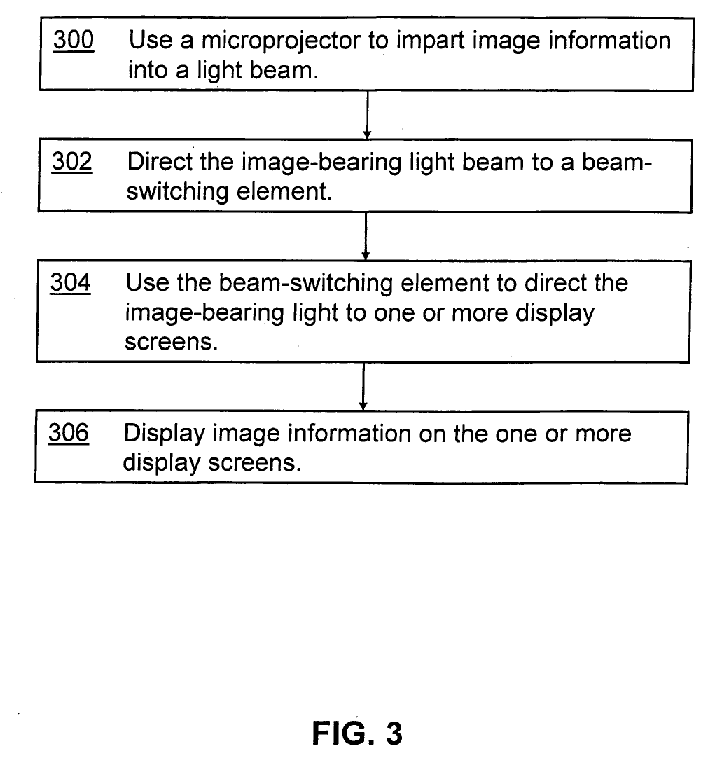

According to aspects of the present invention, FIGS. 2a, 2b, and 2c show alternatives to having these multiple sets of display electronics. FIG. 3 presents an exemplary method of operation of the personal portable device 100 of FIGS. 2a, 2b, and 2c. In the schematic of FIG. 2a, the device 100 contains control logic and display memory 200. In order to display an image, the control logic 200 sends the image to a microprojector 202. The microprojector 202 modulates light in order to imprint image information into a projected light beam (step 300 of FIG. 3).

The projected light beam, modulated to incorporate the image information, is directed to a “beam-switching element” 204 (step 302 of FIG. 3). The beam-switching element 204, under the direction of the control logic 200, can direct the light to one or more display screens (step 304). In FIG. 2a, the beam-switching element 204 directs the image to a rear-projection display screen 206. This image is then viewable by the user 106 of the personal portable device 100 (step 306). In some embodiments, this rear-projection display screen 206 is the same as the main display 102 or the secondary display 104 of the device 100.

FIG. 2b shows the same personal portable device 100 of FIG. 2a but in a different operational mode. In FIG. 2b, the control logic 200 tells the beam-switching element 204 to send the image to an external surface for a projection-display screen. This image passes through an optically clear window 208 on the surface of the device 100 and is projected against a screen or wall, as shown in FIG. 1c. Because one microprojector 202 supports multiple display screens, the device 100 can be built more cheaply and smaller than before.

Several technologies can be used for the microprojector 202. Depending upon economic and engineering factors, the microprojector 202 can incorporate an imager (either reflective or transmissive) or a laser or can be a hybrid.

There are also a number of ways of building the beam-switching element 204. A physically movable mirror can be used where the mirror moves between a first position when the display screen 206 is in use to a second position when the projection display is used. Semi-transparent and electrically configurable mirrors are also usable.

FIG. 2c shows an embodiment of the personal portable device 100 where the beam-switching element 204 is able to simultaneously send images to two different display screens 206 and 208. In one case, the beam-switching element 204 is electrically configurable, and in the scenario of FIG. 2c it is configured to reflect part of the light incident on it to the rear-projection display screen 206 while passing the remainder of the light to the projection display 208 (step 304 of FIG. 3).

In another case, the beam-switching element 204 and the microprojector 202 are configured to simultaneously display a first image on the display screen 206 and a different image on the display 208. The microprojector 202 creates both images, possibly on different portions of its display area, and the beam-switching element 204 is directed to separate the images and to send them to the appropriate displays screens 206 and 208.

When different images are displayed simultaneously, they may be of the same or of different resolutions. For example, the image on the projection display 208 may be of high resolution, while a low-resolution status message is shown on the local display screen 206. The images, different or the same, and their resolutions, different or the same, are under the control of the control logic 200. The control logic 200 can direct the microprojector 202 so that some of its pixels are allocated to the projection display 208, while others are allocated to the local display screen 206. In some embodiments, the microprojector 202 has VGA resolution, that is, 640×480 pixels. Embodiments of the present invention are compatible with other image resolutions.

In some embodiments, the control logic 200 also varies the amount of power used by the microprojector 202 depending upon which, and how many, displays are in use at any one time. Because a projected image 108 is usually rather large and is often shown on a less-than-ideal surface, it often requires more light than is necessary to show an image on a local display screen 206. Thus, the control logic 200 may decrease the power used by the microprojector 202 whenever the projection display 208 is not in use. This feature gives the personal portable device 100 the ability to project images without incurring the cost of always driving the microprojector 202 at full power.

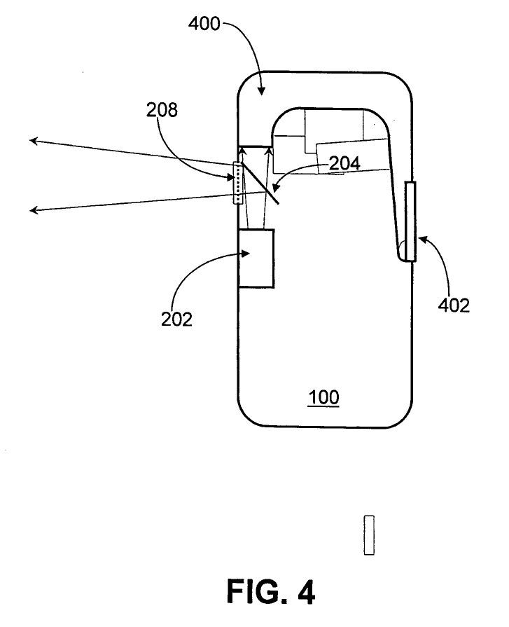

The embodiment in FIG. 4 illustrates the packaging flexibility provided by some aspects of the present invention. In FIG. 4, the microprojector 202 and the beam-switching element 204 are located on one side of the personal portable device 100. Images can be directed to a projection display 208 on this same side of the device 100. The beam-switching element 204 can also direct images to a display 402 located on the other side of the device 100. To bring images from the beam-switching element 204 across the width of the device 100 to the display 402, a curved light guide 400 is provided.

Light guides can be used in conjunction with other embodiments (such as those of FIGS. 2a, 2b, and 2c) in order to enhance flexibility in locating components such as the displays 206, 208, and 402 and the microprojector 202. For example, the microprojector 202 and the beam-switching element 204 can be located in a base of the personal portable device 100, while a flexible light guide can carry image information across a hinge to a display on a cover portion of the device 100.

In view of the many possible embodiments to which the principles of the present invention may be applied, it should be recognized that the embodiments described herein with respect to the drawing figures are meant to be illustrative only and should not be taken as limiting the scope of the invention. For example, the light paths in the figures are only meant to illustrate the functions of the various components and are not meant to be definitive. Other arrangements of the optical components shown in the figures and the addition of other known optical components are possible and may be called for in various environments. Therefore, the invention as described herein contemplates all such embodiments as may come within the scope of the following claims and equivalents thereof.

We claim:

1. An image display system comprising:
a microprojector configured for modulating light in a light path to impart image information onto the light path; and
a beam-switching element configurable for directing modulated light towards each of a plurality of display screens.

2. The image display system of claim 1 wherein the microprojector is selected from the group consisting of: an imager-based projector, a laser projector, and a hybrid projector.

3. The image display system of claim 1 wherein the beam-switching element comprises an element selected from the group consisting of: a movable mirror, a semi-transparent mirror, and an electrically configurable mirror.

4. The image display system of claim 1 wherein the beam-switching element is configurable to simultaneously direct modulated light towards a plurality of the display screens.

5. The image display system of claim 4 configurable to simultaneously display different images on two of the plurality of display screens.

6. The image display system of claim 1 wherein the display screens are selected from the group consisting of: a direct-view display, a rear-projection screen, and a projection screen.

7. The image display system of claim 6 wherein the image display system is configurable to draw less power when the projection display screen is not used.

8. The image display system of claim 1 wherein resolutions of two of the plurality of display screens differ from one another.

9. A method for displaying image information, the method comprising:
at a microprojector, modulating light, the modulated light comprising image information;
directing modulated light from the microprojector towards a first of a plurality of display screens;
displaying image information on the first display screen;
directing modulated light from the microprojector towards a second of the plurality of display screens, the second display screen distinct from the first display screen; and
displaying image information on the second display screen.

10. The method of claim 9 wherein directing modulated light towards the first display screen comprises using a mirror.

11. The method of claim 9 wherein directing modulated light towards the first display screen comprises using a light guide.

12. The method of claim 9 wherein displaying image information on the first display screen comprises projecting modulated light onto a display screen.

13. The method of claim 9 wherein modulated light is simultaneously directed towards the first and second display screens.

14. The method of claim 13 wherein the image information displayed on the first display screen differs from the image information displayed on the second display screen.

15. The method of claim 9 wherein resolutions of the first and second display screens differ from one another.

16. A personal portable device comprising:
a memory configured for storing image information;
a display screen; and
an image display system comprising:
a microprojector configured for modulating light in a light path to impart image information onto the light path; and
a beam-switching element configurable for directing modulated light towards each of a plurality of display screens.

17. The personal portable device of claim 16 wherein the device is selected from the group consisting of: a cellular telephone, a personal digital assistant, and a personal computer.

18. The personal portable device of claim 16 wherein the display screens are selected from the group consisting of: a direct-view display, a rear-projection screen, and a projection screen.

19. The personal portable device of claim 18 further comprising:
an optically clear window to allow an image to be projected beyond the personal portable device to the projection display screen.

20. The personal portable device of claim 16 further comprising:
a curved light guide configurable for directing modulated light from the beam-switching element located on one side of the personal portable device toward a display screen located on another side of the personal portable device.

21. The personal portable device of claim 16 further comprising:
a controller for configuring the beam-switching element to direct modulated light toward a selected set of the plurality of display screens.
